(19) United States
(12) Patent Application Publication
(10) Pub. No.: US 2026/0274604 A1
(43) Pub. Date: Sep. 17, 2026

(54) Tape Attachment Apparatus and Tape Attachment Method

(71) Applicant: SK On Co., Ltd., Seoul (KR)

(72) Inventor: Joon-Ho BAE, Daejeon (KR)

(21) Appl. No.: 19/147,750

(22) PCT Filed: Mar. 28, 2024
(86) PCT No.: PCT/KR2024/003964

§ 371 Date: Jul. 14, 2025

(30) Foreign Application Priority Data
Apr. 3, 2023 (KR) 10-2023-0043734

(51) Int. Cl. B65H 35/00; B65H 35/06; H01M 50/211; H01M 50/262

(52) U.S. Cl. CPC B65H 35/0013; B65H 35/0086; B65H 35/06; H01M 50/211; H01M 50/262; B65H 2301/51512; B65H 2301/51532

(57) ABSTRACT

A tape attachment apparatus may comprise: a cell assembly supply unit that accommodates a cell assembly including a plurality of battery cells; and a tape supply unit for attaching, to the cell assembly, a tape for connecting the plurality of battery cells to each other. The tape supply unit may include an adsorption pad configured to be attached to a central area of the tape, and an attachment roller for closely attaching the tape to the cell assembly. The attachment roller may be configured to perform: a first operation of, before the tape comes into contact with the cell assembly, moving the tape from the central area of the tape toward an end area of the tape; a second operation of bringing the end area into contact with the cell assembly; and a third operation of pressing the tape.

### CROSS-REFERENCE TO RELATED APPLICATIONS

This application is a National Stage Entry of International Patent Application No. PCT/KR2024/003964, filed Mar. 28, 2024, which claims benefit and priority to Korean Patent Application No. KR 10-2023-0043734, filed Apr. 3, 2023, each of which is incorporated by reference in their entireties for all purposes.

### TECHNICAL FIELD

The present disclosure relates to a tape attachment apparatus and a tape attachment method, and relates to a tape attachment apparatus for a battery cell assembly and a tape attachment method for a battery cell assembly.

### BACKGROUND ART

Secondary batteries, unlike primary batteries, may be charged with or discharged of electricity, and may be applied to devices within various fields such as digital cameras, mobile phones, laptop computers, hybrid cars, electric cars, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid square or cylindrical can-type battery cells. A plurality of battery cells may be formed into a cell assembly in a stacked form. The cell assembly may be disposed inside a module housing to form a battery module, and a plurality of battery modules may be disposed inside a pack housing to form a battery pack.

### DISCLOSURE OF INVENTION

### Technical Problem

A cell assembly includes a plurality of battery cells. The plurality of battery cells may be connected using tape. However, when the battery cells are manually connected by a worker, work speed and quality reliability may be reduced.

In addition, when the tape is attached to the cell assembly by a tape attachment apparatus, the cell assembly may be damaged by force transmitted to the battery cell during a tape attachment process.

The present disclosure provides a tape attachment apparatus that may automatically attach tape to a cell assembly, and a tape attachment method.

The present disclosure is to provide a tape attachment apparatus that may reduce damage to a battery cell occurring when a tape is attached to a cell assembly, and a tape attachment method.

A tape manufactured using a tape attachment apparatus and a tape attachment method of the present disclosure may be included in a cell assembly. The cell assembly may be widely applied to electric vehicles, battery charging stations, and devices within green technology fields such as solar and wind power generation devices using other batteries. In addition, a cell assembly including a tape manufactured using the tape attachment apparatus and the tape attachment method of the present disclosure may be used in eco-friendly electric vehicles, hybrid vehicles, or the like, to ameliorate the effects of climate change by suppressing air pollution and greenhouse gas emissions.

### Solution to Problem

A tape attachment apparatus may include: a cell assembly supply unit accommodating a cell assembly including a plurality of battery cells; and a tape supply unit for attaching, to the cell assembly, a tape for connecting the plurality of battery cells to each other. The tape supply unit may include: an adsorption pad configured to be attached to a central area of the tape; and an attachment roller for closely attaching the tape to the cell assembly. The attachment roller may be configured to perform: a first operation of, before the tape comes into contact with the cell assembly, moving the tape from the central area of the tape toward an end area of the tape; a second operation of bringing the end area into contact with the cell assembly; and a third operation of closely attaching the tape from the end area to a bending area of the tape.

According to an embodiment, the adsorption pad may move in a first direction toward the cell assembly.

According to an embodiment, the adsorption pad may move in a second direction, perpendicular to the first direction, in the first operation, and may move in a third direction opposite to the first direction, in the third operation.

According to an embodiment, the attachment roller may include a first attachment roller and a second attachment roller spaced apart from the first attachment roller. In the first operation, a direction in which the first attachment roller moves may be opposite to a direction in which the second attachment roller moves. In the third operation, the direction in which the first attachment roller moves may be parallel to the direction in which the second attachment roller moves.

According to an embodiment, the adsorption pad may be disposed between the first attachment roller and the second attachment roller.

According to an embodiment, the tape supply unit may include a guide member configured to contact a bending area between the central area and the end area and to bend the bending area.

According to an embodiment, the tape supply unit may include: a bobbin configured to wind the tape, and at least one guide roller for controlling tension of the tape.

According to an embodiment, the tape supply unit may include: a gripper configured to fix the tape; and a tape cutting portion including a blade configured to cut the tape, and a slider configured to move the blade in a second direction, perpendicular to a first direction in which the tape moves.

According to an embodiment, each of the plurality of battery cells may include an electrode plate and an electrode lead connected to the electrode plate. The cell assembly may include a first surface oriented in the same direction as the electrode lead, a second surface at least partially perpendicular to the first surface, and a third surface at least partially perpendicular to the first surface and at least partially parallel to the second surface. The adsorption pad may be configured to face the first surface. The attachment roller may be configured to face the second surface and the third surface.

According to an embodiment, the cell assembly may include a corner portion disposed between the first surface and the second surface or between the first surface and the third surface. The attachment roller may be configured to closely attach the tape from the second surface or the third surface to the corner portion of the cell assembly.

A tape attachment method of the present disclosure may include: a process of attaching an adsorption pad to a central area of a tape; a process of moving an attachment roller from the central area toward an end area of the tape; a process of bringing the central area into contact with a cell assembly using the adsorption pad; a process of bringing the end area into contact with the cell assembly using the attachment roller; and a process of closely attaching the tape to the cell assembly using the attachment roller.

According to an embodiment, the process of bringing the central area into contact with a cell assembly using the adsorption pad may include an operation of moving the adsorption pad in a first direction oriented toward the cell assembly, and the process of moving an attachment roller from the central area toward an end area of the tape may include an operation of moving the attachment roller in a second direction, perpendicular to the first direction.

According to an embodiment, the process of closely attaching the tape to the cell assembly using the attachment roller may include an operation of moving the attachment roller in a third direction opposite to the first direction from the end area to a bending area of the tape.

### Advantageous Effects of Invention

In an embodiment, when a tape is attached to a cell assembly, force applied to a battery cell may be reduced, thereby preventing or reducing breakage of the battery cell.

### BRIEF DESCRIPTION OF DRAWINGS

FIG. 1 is a perspective view of a cell assembly according to an embodiment.

FIG. 2 is a schematic diagram of a tape attachment apparatus according to an embodiment.

FIGS. 3a to 3d are schematic diagrams illustrating a tape attachment process for a cell assembly according to an embodiment.

FIG. 4 is a flowchart illustrating a tape attachment method for a cell assembly according to an embodiment.

### BEST MODE FOR THE INVENTION

Hereinafter, the present disclosure will be described in detail with reference to the attached drawings. However, this is merely exemplary and the present disclosure is not limited to the specific embodiments described as exemplary.

The terms used in the specification and the appended claims described below should not be construed as being limited to general and dictionary meanings, but interpreted based on the meanings and concepts corresponding to technical aspects of the present disclosure on the basis of the principle that the inventor is allowed to define terms appropriately for the best explanation.

Therefore, it should be understood that the embodiments described in this specification and the configurations illustrated in the drawings are only the most desirable embodiments of the disclosed technology and do not represent all the technical concepts of disclosed technology, and accordingly, there may be various equivalents and variations that may replace the embodiments and the configurations of the disclosed technology at the time of this application.

Hereinafter, embodiments of the present disclosure will be described with reference to the attached drawings. In this case, in the attached drawings, the same components are represented by the same symbols as much as possible. In addition, detailed descriptions of known functions and configurations that may obscure the gist of the present disclosure are omitted. In the attached drawings, some components are exaggerated, omitted, or schematically depicted, and the size of each component does not entirely reflect the actual size.

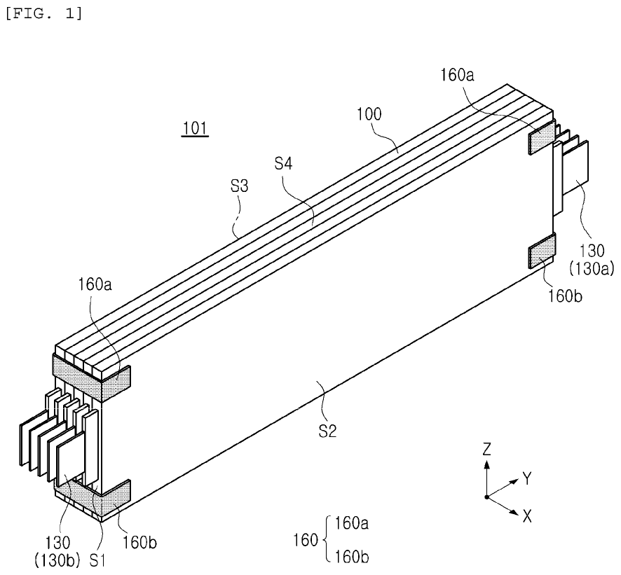

FIG. 1 is a perspective view of a cell assembly according to an embodiment.

Referring to FIG. 1, a cell assembly 101 may include a plurality of battery cells 100 and a tape 160 connecting the plurality of battery cells 100. The tape 160 may be referred to as an adhesive tape or an adhesive material.

The battery cell 100 of FIG. 1 may be a secondary battery. For example, the battery cell 100 may be a lithium ion battery, but is not limited thereto. For example, the battery cell 100 may be a nickel-cadmium battery, a nickel-metal hydride battery, or a nickel-hydrogen battery, which is capable of being charged with or discharged of electricity.

A shape of the battery cell 100 may be selectively designed. For example, the battery cell 100 may be a pouch-type battery or a square battery. When the battery cell 100 is provided as a pouch-type battery, the tape 160 may be attached to a surface of a pouch of the battery cell 100. When the battery cell 100 is provided as a square battery, the tape 160 may be attached to a surface of a can of the battery cell 100.

The battery cell 100 may include an electrode lead 130. The electrode lead 130 may be electrically connected to an electrode assembly (not shown) disposed inside the battery cell 100. The electrode lead 130 may be used to transmit a current of the battery cell 100 to the outside of the battery cell 100. For example, the electrode lead 130 may be electrically connected to a bus bar. In an embodiment, the electrode leads 130 may be disposed on both sides of the battery cell 100 in a longitudinal direction (Y-axis direction) so as to be oriented in opposite directions. For example, the electrode lead 130 may include a cathode lead 130a having a first polarity (e.g., a cathode) facing one side of the battery cell 100 in a longitudinal direction (e.g., a first direction (+Y-direction)), and an anode lead 130b having a second polarity (e.g., an anode) facing the other side thereof in a longitudinal direction (e.g., a third direction (−Y-direction)). A direction in which the electrode lead 130 is disposed may be selectively designed. In an embodiment (e.g., FIG. 1), the electrode lead 130 may include a cathode lead 130a and an anode lead 130b disposed in an opposite direction to the cathode lead 130a based on an electrode assembly 120. In FIG. 1, the electrode leads 130 are illustrated as being disposed so as to be oriented in opposite directions on both sides of the battery cell 100 in the longitudinal direction (e.g., a Y-axis direction), but the structure of the electrode lead 130 is not limited thereto. For example, the two electrode leads 130 may be disposed to be substantially parallel in the longitudinal direction (e.g., Y-axis direction) of the battery cell 100.

The electrode assembly, not shown, may include a cathode plate, an anode plate, and a separator. The separator may prevent contact between the cathode plate and the anode plate. Those skilled in the art will appreciate that the electrode assembly may be manufactured using various methods (e.g., stacking, jelly roll, or Z folding).

Theo cell assembly 101 may have a substantially hexahedral shape. For example, the cell assembly 101 may include a first surface S1 oriented in the same direction (e.g., Y-axis direction) as the electrode leads 130 of the battery cells 100, a second surface S2 at least partially substantially perpendicular to the first surface S1, a third surface S3 substantially parallel to the second surface S2, and a fourth surface S4 substantially perpendicular to the first surface S1 and the second surface S2. The second surface S2 and the third surface S3 may be surfaces defined by a battery cell 100 disposed in an outermost portion, among the plurality of battery cells 100. The fourth surface S4 may be a surface defined by side surfaces of the plurality of battery cells 100. In an embodiment, the cell assembly 101 may be referred to as a cell stack. The tape 160 may be attached to at least portions of the first surface S1 and the second surface S2.

The tape 160 may connect a plurality of battery cells 100. For example, the tape 160 may reduce a movement of the plurality of battery cells 100. According to an embodiment, the tape 160 may be an insulating tape.

According to an embodiment, the tape 160 may be provided in plural. For example, the tape 160 may include a first tape 160a and a second tape 160b spaced apart from the first tape 160a. The electrode lead 130 may be disposed between the first tape 160a and the second tape 160b. According to an embodiment, the tape 160 may be arranged to be adjacent to the cathode lead 130a and the anode lead 130b.

In this document, the tape 160 extending from the second surface S2 through the first surface S1 to the third surface S3 is illustrated, but an attachment position of the tape 160 is not limited thereto. For example, in an embodiment, the tape 160 may extend from the second surface S2 through the fourth surface S4 to the third surface S3.

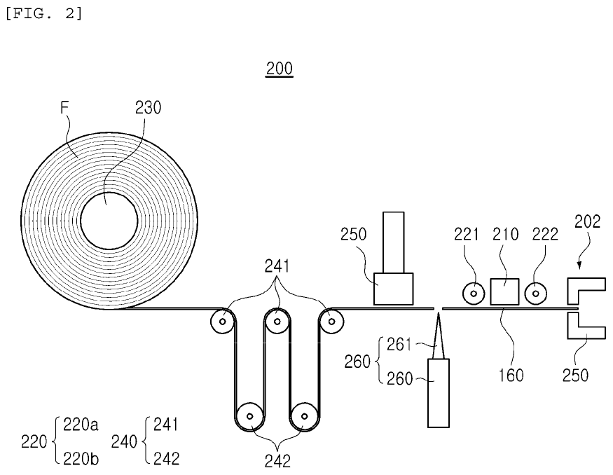

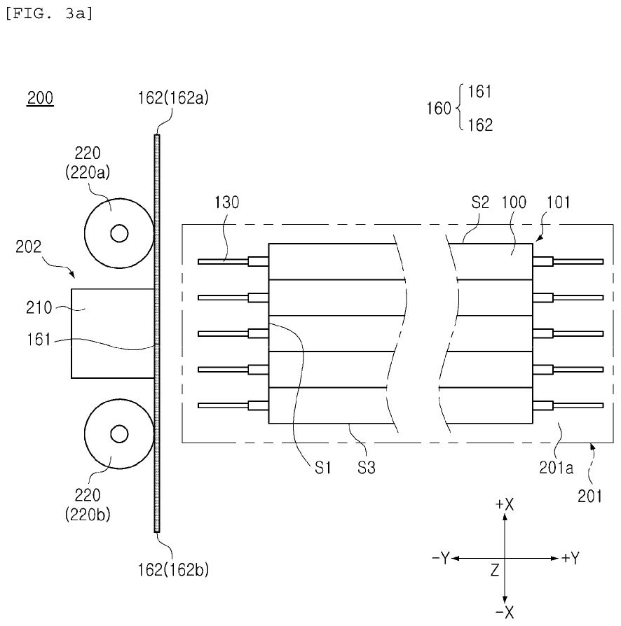

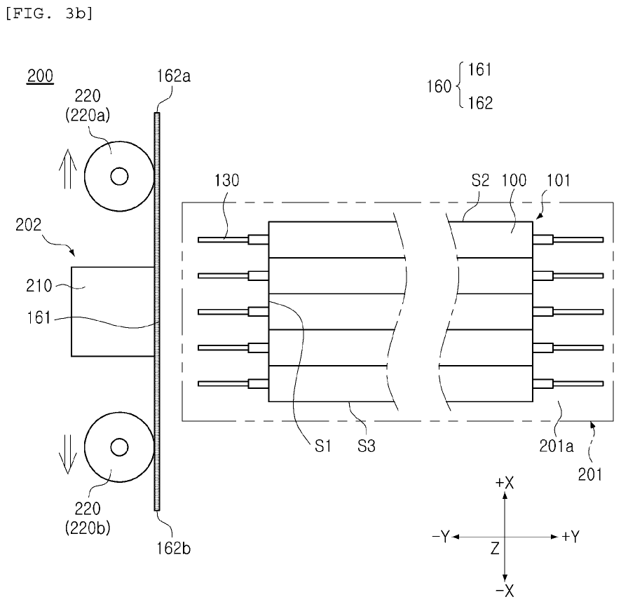

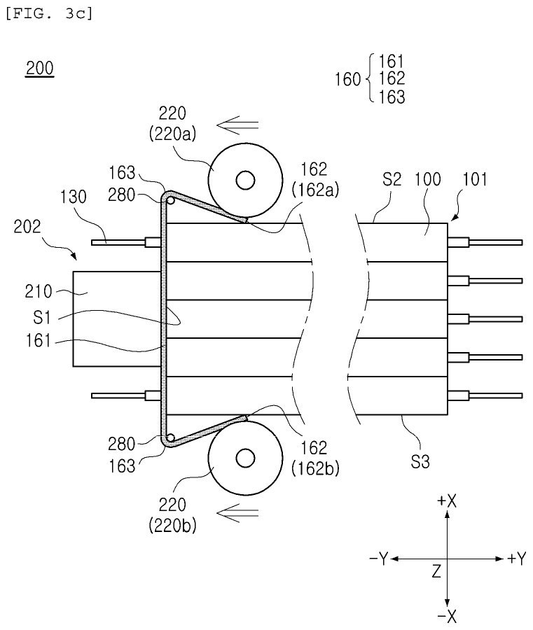

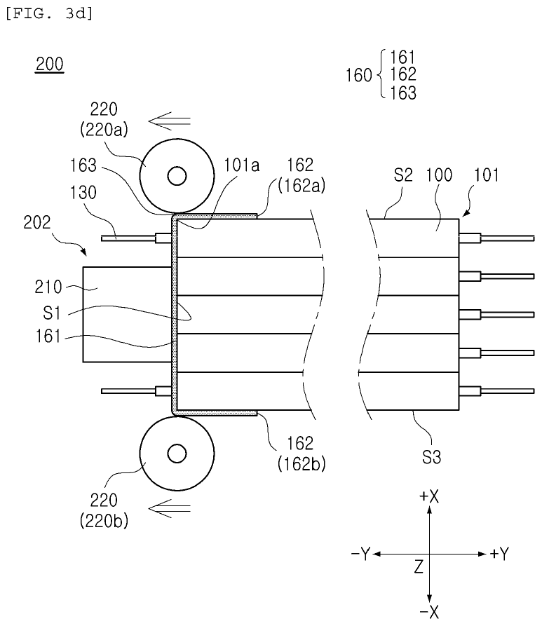

FIG. 2 is a schematic diagram of a tape attachment device according to an embodiment. FIGS. 3a to 3d are schematic diagrams illustrating a tape attachment process for a cell assembly according to an embodiment.

Referring to FIGS. 2, 3a, 3b, 3c and/or 3d, a tape attachment apparatus 200 may include a cell assembly supply unit 201 and a tape supply unit 202. The description of the cell assembly 101 and the tape 160 of FIG. 1 may be applied to the cell assembly 101 and the tape 160 of FIG. 2, FIG. 3a, FIG. 3b, FIG. 3c and/or FIG. 3d.

The tape attachment apparatus 200 may attach the tape 160 to the cell assembly 101 accommodated in the cell assembly supply unit 201 using the tape supply unit 202. For example, the tape attachment apparatus 200 may attach the tape 160 to at least portions of the first surface S1 and the second surface S2 of the cell assembly 101 and may connect a plurality of battery cells 100.

The cell assembly supply unit 201 may accommodate the cell assembly 101. For example, the cell assembly supply unit 201 may include a tray 201a accommodating a cell assembly 101 including a plurality of battery cells 100.

In an embodiment, the cell assembly supply unit 201 may transmit the cell assembly 101 to the tape supply unit 202. For example, the cell assembly supply unit 201 may include a driving structure (e.g., an elevating member, a robot, and/or a conveyor) configured to move the tray 201a. The cell assembly supply unit 201 may move the tray 201a so that the plurality of battery cells 100 are adjacent to the tape supply unit 202. The cell assembly supply unit 201 may be optionally designed. For example, when the cell assembly supply unit 201 moves the cell assembly 101 so that the cell assembly 101 approaches the tape supply unit 202, a structure of the cell assembly supply unit 201 may be changed. For convenience of explanation, the cell assembly supply unit 201 is omitted in FIGS. 3c and 3d.

The tape supply unit 202 may include a film F. The film F may include a base sheet and an adhesive material disposed on the base sheet. The film F may be used to manufacture the tape 160. For example, a portion of the film F may be cut, and the cut film F may be referred to as the tape 160. The film F may be referred to as a tape material.

The tape supply unit 202 may include a bobbin 230 accommodating at least a portion of the film F. For example, at least a portion of the film F may be wound on the bobbin 230. The bobbin 230 may be rotated by driving force transmitted from the outside. As the bobbin 230 rotates, the film F may be released from the bobbin 230 and may be transmitted to an adsorption pad 210. In an embodiment, the bobbin 230 may be referred to as a tape supply roll.

The tape supply unit 202 may include at least one guide roll 240 for controlling a movement direction of the film F. For example, the film F released from the bobbin 230 may move along the guide roll 240.

In an embodiment, the guide roll 240 may adjust the tension of the film F. For example, the guide roll 240 may include at least one fixed roll 241 and at least one dancer roll 242. The dancer roll 242 may move relative to the fixed roll 241. As the dancer roll 242 moves, the tension of the film F may be adjusted. The number and/or size of the guide rolls 240 may be selectively designed.

In an embodiment, the tape supply unit 202 may increase the tension of the film F for cutting the film F. The tape supply unit 202 may include a gripper 250 for fixing an end of the film F. The gripper 250 may grab the end of the film F at specified time intervals or based on an input of a processor. The film F may be cut by a tape cutting portion 260, and then, the gripper 250 may reduce pressure provided to the cut film F (or tape 160). The tape supply unit 202 may include a guide block 270. In an embodiment, the guide block 270 may be in contact with the film F using an elevating cylinder and may provide pressure to the film F. The guide block 270 may be moved to be separated from the film F or tape 160 using the elevating cylinder. At least a portion of the film F may be pulled taut by the gripper 250 and the guide block 270. The tape 160 separated from the gripper 250 and the guide block 270 may be moved by the adsorption pad 210.

The tape supply unit 202 may include a tape cutting portion 260. The tape cutting portion 260 may cut the film F spread by the gripper 250 and the guide block 270. The film F cut by the tape cutting portion 260 may be referred to as a tape 160. The tape cutting portion 260 may be disposed between the guide block 270 and the gripper 250. According to an embodiment, the tape cutting portion 260 may include a blade 261 for cutting the film F and an elevating member 262 for moving the blade 261. The elevating member 262 may move the blade 261 in a direction perpendicular to a movement direction of the film F.

The tape supply unit 202 may include an adsorption pad 210. The adsorption pad 210 may move the tape 160 cut by the tape cutting portion 260. For example, the adsorption pad 210 may vacuum-absorb the tape 160 and may move together with the tape 160. The adsorption pad 210 may be disposed between the tape cutting portion 260 and the gripper 250.

According to an embodiment, the tape supply unit 202 may include a driving structure (not shown) for moving the adsorption pad 210 and/or an attachment roller 220. The driving structure may be designed selectively. For example, the driving structure may include at least one of a driving cylinder, a motor, a robot, or a gear. At least one of the adsorption pad 210 or the attachment roller 220 may be moved by the driving structure.

According to an embodiment, the adsorption pad 210 may be spaced apart from the tape cutting portion 260. For example, in an embodiment, the adsorption pad 210 may be moved independently of the tape cutting portion 260.

In an embodiment, the adsorption pad 210 may attach the tape 160 to the cell assembly 101. For example, the adsorption pad 210 may attach the tape 160 to the first surface S1 of the cell assembly 101.

The adsorption pad 210 may move in a first direction (+Y-direction) toward the cell assembly 101. The tape 160 may move toward the cell assembly 101 together with the adsorption pad 210 and may be in contact with the cell assembly 101. The tape 160 may be temporarily attached to the cell assembly 101 by the adsorption pad 210.

The tape supply unit 202 may include an attachment roller 220. The attachment roller 220 may closely attach the tape 160 to the cell assembly 101. The attachment roller 220 may provide pressure to the tape 160. By the pressure provided by the attachment roller 220, the tape 160 may be attached to a plurality of battery cells 100, and the plurality of battery cells 100 may be connected. Air bubbles generated in the tape 160 may be reduced by force transmitted from the attachment roller 220. By the attachment roller 220, bonding force of the tape 160 bonding the plurality of battery cells 100 may be improved. For example, a contact area between the tape 160 and the battery cells 100 may be improved by the attachment roller 220.

The attachment roller 220 may reduce damage to the cell assembly 101 due to tensile force. For example, the attachment roller 220 may reduce force transmitted to the cell assembly 101, thereby preventing damage to a separator or an electrode plate of the battery cell (e.g., the battery cell 100 of FIG. 1).

According to an embodiment, the attachment roller 220 may include a first attachment roller 220a and a second attachment roller 220b that may be spaced apart from the first attachment roller 220a.

Referring to FIG. 3a, the adsorption pad 210 may be attached to a central area 161 of the tape 160. The adsorption pad 210 may be moved together with the tape 160 so that the tape 160 faces the first surface S1 of the cell assembly 101. The attachment roller 220 may be moved together with the adsorption pad 210 in a state in which at least a portion of the attachment roller (220) is adjacent to the central area 161. In another embodiment, the cell assembly 101 and/or the tray 201a may be moved, so that the tape 160 may face the cell assembly 101.

Referring to FIG. 3b, the attachment roller 220 may perform a first operation of moving toward an end area 162 of the tape 160. For example, the attachment roller 220 may move along a second direction (X-axis direction) from the central area 161 of the tape 160 toward the end area 162 of the tape 160. In an embodiment, a direction in which the first attachment roller 220a moves in the first operation may be opposite to a direction in which the second attachment roller 220b moves. For example, the first attachment roller 220a may move toward a first end 162a of the tape 160 (e.g., in a +X-direction), and the second attachment roller 220b may move toward a second end 162b opposite the first end 162a (e.g., in the −X-direction). In an embodiment, the end area 162 may be referred to as a peripheral region.

Referring to FIG. 3c, the adsorption pad 210 and the attachment roller 220 may bring the tape 160 into contact with the cell assembly 101. According to an embodiment, the adsorption pad 210 may contact or temporarily attach the central area 161 of the tape 160 to the first surface S1 of the cell assembly 101. The attachment roller 220 may perform a second operation of contacting or temporarily attaching the end area 162 of the tape 160 to the second surface S2 or the third surface S3 of the cell assembly 101.

According to an embodiment, the adsorption pad 210 may move to approach the cell assembly 101 after the first operation in which the attachment roller 220 moves toward the end area 162 of the tape 160. For example, the adsorption pad 210 may move toward the first surface S1 of the cell assembly 101 in the first direction (+Y-direction), perpendicular to the second direction (X-axis direction). By the movement of the adsorption pad 210, the central area 161 of the tape 160 may be in contact with the cell assembly 101.

In an embodiment, the attachment roller 220 may perform a second operation of bringing the end area 162 into contact with the cell assembly 101, after the first operation.

The second operation may include a horizontal movement operation in which the attachment roller 220 moves in the first direction (+Y-direction). For example, the attachment roller 220 may move together with the adsorption pad 210. In an embodiment, the second operation may include a vertical movement operation of bringing the end area 162 into contact with the cell assembly 101 after the horizontal movement operation. For example, the attachment roller 220 may move in the second direction (X-axis direction) to bring the end area 162 of the tape 160 into contact with the cell assembly 101.

In an embodiment, when the attachment roller 220 moves in the second direction, the tape 160 may be bent by a guide member 280. For example, the tape 160 may include a bending area 163 disposed between the central area 161 and the end area 162, and in the bending area 163, the tape 160 may be bent.

In an embodiment, the guide member 280 may bend the tape 160. For example, the guide member 280 may be in contact with the bending area 163. As the tape 160 is moved by the adsorption pad 210 and/or the attachment roller 220, a portion of the tape 160 (e.g., the bending area 163) in contact with the guide member 280 may be bent.

In an embodiment, the guide member 280 may be moved along a fourth direction (Z-axis direction), perpendicular to the first direction or the second direction. As the guide member 280 is moved in the fourth direction, the guide member 280 may be disposed between the tape 160 and the cell assembly 101.

In an embodiment, the guide member 280 may include a spring. For example, the guide member 280 may be a spring plate. A structure of the guide member 280 may be optionally designed. For example, the guide member 280 may be moved in the fourth direction (Z-axis direction) using another driving device.

Referring to FIG. 3d, the attachment roller 220 may perform a third operation of closely attaching the tape 160 from the end area 162 to the bending area 163 of the tape 160. For example, after the end area 162 of the tape 160 is in contact with the cell assembly 101, the attachment roller 220 may be moved along the third direction (−Y-direction) opposite to the first direction. The tape 160 may include a bending area 163 facing a corner portion 101a of the cell assembly 101. The bending area 163 may be disposed between the central area 161 and the end area 162. The attachment roller 220 may move from the end area 162 to the bending area 163 while providing pressure to the tape 160. In an embodiment, the tape 160 may be formed of an elastic material. In an embodiment not shown, at least a portion of the bending area 163 may protrude. For example, by the third operation, portions of the tape 160 may overlap each other. In an embodiment, the corner portion 101a of the cell assembly 101 may be a corner between the first surface S1 and the second surface S2 of the cell assembly 101 and/or a corner between the first surface S1 and the third surface S3 of the cell assembly 101.

In an embodiment, the adsorption pad 210 may be removed from the tape 160. When the adsorption pad 210 is separated from the tape 160, the adsorption pad 210 may apply force in the first direction (+Y-direction) to the tape 160 and/or the cell assembly 101. The attachment roller 220 may move in the third direction (−Y-direction) opposite to the first direction (+Y-direction) and may simultaneously apply force in the third direction (−Y-direction) to the tape 160 and/or the cell assembly 101. Since a direction of the force applied by the adsorption pad 210 to the cell assembly 101 and a direction of the force applied by the attachment roller 220 to the cell assembly 101 are different, tensile force transmitted to the tape 160 and/or force transmitted to the cell assembly 101 may be reduced. A reduction in the tensile force and/or force may reduce the damage to the cell assembly 101 and/or the tape 160. For example, the damage to the cell assembly (e.g., the electrode plate and/or the separator) of the battery cell 100 may be reduced. A detachment of the electrode plate of the battery cell 100 may be reduced.

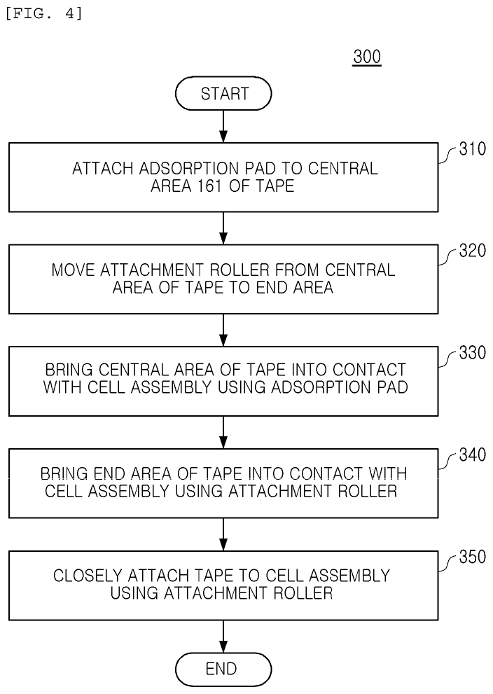

FIG. 4 is a flowchart illustrating a tape attachment method of a cell assembly according to an embodiment.

A tape attachment method 300 of FIG. 4 may be a method of attaching a tape 160 to a cell assembly 101 using the tape attachment apparatus 200 of FIGS. 2 to 3d. The description of the tape 160 and the tape attachment apparatus 200 described in FIGS. 2 to 3d may be applied to FIG. 4.

Referring to FIG. 4, the tape attachment method 300 may include a process (310) of attaching an adsorption pad 210 to a central area 161 of a tape 160, a process (320) of moving an attachment roller 220 from the central area 161 of the tape 160 to an end area 162, a process (330) of bringing the central area 161 of the tape 160 into contact with the cell assembly 101 using the adsorption pad 210, a process (340) of bringing the end area 162 of the tape 160 into contact with the cell assembly 101 using the attachment roller 220, and/or a process (350) of closely attaching the tape 160 to the cell assembly 101 using the attachment roller 220.

According to an embodiment, in the process (310) of attaching the adsorption pad 210 to the central area 161 of the tape 160, the adsorption pad 210 may be attached to the tape 160 cut by the tape cutting portion 260. When the adsorption pad 210 is attached to the central area 161 of the tape 160, at least a portion of the attachment roller 220 may face the central area 161. In an embodiment, the adsorption pad 210 may be moved using a separate driving device (e.g., a cylinder).

In the process (320) of moving the attachment roller 220 from the central area 161 of the tape 160 to the end area 162, the attachment roller 220 may be moved using a separate driving device. According to an embodiment, when the attachment roller 220 includes a plurality of attachment rollers (e.g., the first attachment roller 220a and the second attachment roller 220b of FIG. 3a), and the attachment roller 220 moves toward the end area 162, the first attachment roller 220a may move in a direction away from the second attachment roller 220b. For example, a direction in which the first attachment roller 220a moves may be opposite to a direction in which the second attachment roller 220b moves.

The process (330) of bringing the end area 162 of the tape 160 into contact with the cell assembly 101 using the attachment roller 220 may include an operation of moving the attachment roller 220 in the first direction (e.g., the +Y-direction of FIG. 3c), and an operation of moving the attachment roller 220 in the second direction (e.g., the X-axis direction of FIG. 3a), perpendicular to the first direction (+Y-direction). The attachment roller 220 may bend the tape 160. For example, a portion of the tape 160 may be bent by the attachment roller 220 and a guide member (e.g., the guide member 280 of FIG. 3c).

The process (340) of closely attaching the tape 160 to the cell assembly 101 using the attachment roller 220 may include an operation of moving the attachment roller 220 in the third direction (−Y-direction) opposite to the first direction (+Y-direction) from the end area 162 of the tape 160 to the bending area 163 of the tape 160.

The contents described above are merely examples of applying the principles of the present disclosure, and other components may be further included within a scope that does not depart from the scope of the present disclosure.

Although the embodiments of the present invention have been described above, the scope of the rights of the present invention is not limited thereto, and it will be apparent to those skilled in the art that various modifications and variations may be possible within a scope that does not depart from the technical concept of the present disclosure described in the claims. For example, the present disclosure may be implemented by deleting some components from the above-described embodiments, and respective embodiments may be implemented in combination with each other.

1. A tape attachment apparatus, comprising:
a cell assembly supply unit accommodating a cell assembly including a plurality of battery cells; and
a tape supply unit for attaching, to the cell assembly, a tape for connecting the plurality of battery cells to each other,
wherein the tape supply unit includes:
an adsorption pad configured to be attached to a central area of the tape; and
an attachment roller for closely attaching the tape to the cell assembly,
wherein the attachment roller may be configured to perform: a first operation of, before the tape comes into contact with the cell assembly, moving the tape from the central area of the tape toward an end area of the tape; a second operation of bringing the end area into contact with the cell assembly; and a third operation of closely attaching the tape from the end area to a bending area of the tape.

2. The tape attachment apparatus of claim 1, wherein the adsorption pad is configured to move in a first direction toward the cell assembly.

3. The tape attachment apparatus of claim 2, wherein the adsorption pad is configured to move in a second direction, perpendicular to the first direction, in the first operation, and to move in a third direction opposite to the first direction, in the third operation.

4. The tape attachment apparatus of claim 3, wherein the attachment roller includes a first attachment roller and a second attachment roller spaced apart from the first attachment roller,
in the first operation, a direction in which the first attachment roller moves is opposite to a direction in which the second attachment roller moves, and
in the third operation, the direction in which the first attachment roller moves is parallel to the direction in which the second attachment roller moves.

5. The tape attachment apparatus of claim 4, wherein the adsorption pad is configured to be disposed between the first attachment roller and the second attachment roller.

6. The tape attachment apparatus of claim 1, wherein the tape supply unit includes a guide member configured to contact a bending area between the central area and the end area and to bend the bending area.

7. The tape attachment apparatus of claim 1, wherein the tape supply unit includes:
a bobbin configured to wind the tape, and
at least one guide roller for controlling tension of the tape.

8. The tape attachment apparatus of claim 1, wherein the tape supply unit includes:
a gripper configured to fix the tape; and
a tape cutting portion including a blade configured to cut the tape, and a slider configured to move the blade in a second direction, perpendicular to a first direction in which the tape moves.

9. The tape attachment apparatus of claim 1, wherein each of the plurality of battery cells includes an electrode plate and an electrode lead connected to the electrode plate,
the cell assembly includes a first surface oriented in the same direction as the electrode lead, a second surface at least partially perpendicular to the first surface, and a third surface at least partially perpendicular to the first surface and at least partially parallel to the second surface,
the adsorption pad is configured to face the first surface, and
the attachment roller is configured to face the second surface and the third surface.

10. The tape attachment apparatus of claim 9, wherein the cell assembly includes a corner portion disposed between the first surface and the second surface or between the first surface and the third surface, and
the attachment roller is configured to closely attach the tape from the second surface or the third surface to the corner portion of the cell assembly.

11. A tape attachment method, comprising:
a process of attaching an adsorption pad to a central area of a tape;
a process of moving an attachment roller from the central area toward an end area of the tape;
a process of bringing the central area into contact with a cell assembly using the adsorption pad;
a process of bringing the end area into contact with the cell assembly using the attachment roller; and
a process of closely attaching the tape to the cell assembly using the attachment roller.

12. The tape attachment method of claim 11, wherein the process of bringing the central area into contact with a cell assembly using the adsorption pad includes an operation of moving the adsorption pad in a first direction oriented toward the cell assembly, and
the process of moving an attachment roller from the central area toward an end area of the tape includes an operation of moving the attachment roller in a second direction, perpendicular to the first direction.

13. The tape attachment method of claim 12, wherein the process of closely attaching the tape to the cell assembly using the attachment roller includes an operation of moving the attachment roller in a third direction opposite to the first direction from the end area to a bending area of the tape.
